(19) United States
(12) Patent Application Publication
(10) Pub. No.: US 2019/0309201 A1
(43) Pub. Date: Oct. 10, 2019

(54) SINTERED ABRASIVE PARTICLE COMPRISING OXIDES PRESENT IN BAUXITE

(71) Applicant: IMERTECH SAS, Paris (FR)

(72) Inventors: David DUMONT, Gardanne (FR); Ségolène BERZATI, Venelles (FR)

(21) Appl. No.: 16/311,307

(22) PCT Filed: Jun. 15, 2017
(86) PCT No.: PCT/FR2017/051545

§ 371 Date: Dec. 19, 2018

(30) Foreign Application Priority Data
Jun. 22, 2016 (FR) 1655796

(51) Int. Cl. C09K 3/14; C04B 35/111; C04B 35/626; C04B 35/64

(52) U.S. Cl. CPC C09K 3/1418; C04B 2235/785; C04B 35/6261; C04B 35/62695; C04B 35/64; C04B 2235/3217; C04B 2235/3272; C04B 2235/3232; C04B 2235/3208; C04B 2235/3206; C04B 2235/3418; C04B 2235/5436; C04B 2235/606; C04B 2235/656; C04B 2235/77; C04B 35/1115

(57) ABSTRACT

The invention relates to sintered abrasive particles of which the chemical composition comprises the weight concentration ranges indicated in the table, to give a total of 100%.

| % Fe₂O₃ | % TiO₂ | % CaO | % MgO | % SiO₂ | % Al₂O₃ |
|---|---|---|---|---|---|
| 0.5-2.5% | 0-2% | 0.5-2.5% | 0.5-3% | 0.5-3% | 93-96.5% |

The invention concerns the field of sintered abrasive particles often referred to as “abrasive grains” used for the development of abrasive tools.

In particular, the invention concerns sintered abrasive grains of synthetic composition with a high content of alumina with the following additives naturally present in bauxite, namely Fe₂O₃, TiO₂, SiO₂, MgO and CaO.

The invention is in particular aimed at the field of agglomerated abrasive products in which the abrasive grains are dispersed in a resin-based binder, typically grinding wheels. Applied abrasives are typically abrasive powders deposited on various media such as paper, fabric, tape, etc.

Even if it is applied to all types of abrasives, the present invention is in particular aimed at the manufacture of bonded abrasives, such as those used to produce grinding wheels for scarfing steel slabs, for deburring raw cast parts or for grinding metals.

The abrasive grains must present good mechanical properties, such as resistance or solidity and good cutting capability.

Solidity characterises the propensity of the grain to fracture by generating fragments that tend to “regenerate its edges” under the effect of mechanical force. The product tested is calibrated according to the grain to be tested. After mechanical force (rotation in a jar loaded with ball bearings), the sample is sifted according to a column of several sieves whose meshes have been pre-defined. As is known, a specific coefficient is allocated to each fraction recovered, which allows classification of the quality performance in terms of solidity, expressed as a barycentric average of the content relating to each fraction (expressed as a percentage). The greater the solidity, the closer the value obtained must be to 100.

Solidity is distinguished by hardness with regard to the abrasive properties. A very hard grain may be fragile and its rupture may have a beneficial effect, for example the appearance of new sharp edges, as well as negative effects, for example a reduction in cutting power, poor finishing, etc. Conversely, a less hard grain may be less fragile and may in the end turn out to be better at “regenerating its edges”.

The cutting power is the property possessed by the grain to conserve the cutting angles as well as to fracture, giving new cutting angles. It may be characterised by its material removal performance, quantified for example with the aid of the G [grinding] ratio=quantity of material removed/quantity of abrasive used (or in English referred to as the Q Ratio). For applications of bonded abrasives, certain conditions of use, such as the scarfing of steel alloy metal sheets, may require the abrasive grain to give the product cutting performance of the order of 200 to 2000 kg/h by undergoing very strong pressure (up to 55 daN/cm² under extreme conditions) coupled with a peripheral temperature that may reach 1000° C.

The cutting power or G ratio of an abrasive product is correlated to a compression measuring the energy required to break the grains as far as their total disintegration, described below.

U.S. Pat. No. 9,073,177 gives a description of abrasive grains obtained by sintering using natural bauxite presenting variable compositions of about 80%-89% of Al₂O₃, 3%-9% of TiO₂ and Fe₂O₃, 2.5%-4% of SiO₂ and 0.1% to 1% of CaO and MgO and whose crystalline microstructure is relatively fine with average crystallite sizes of 0.01 to 1.2 μm and a porosity rage of between 0% and 15%. In fact, these particles obtained from natural bauxite coming from the applicant (formerly ALCAN) as cited in U.S. Pat. No. 9,073,177 (see column 10 lines 12-17) as sample S1, S2 and CS2 or from the company TREIBACHER for sample CS1 (see column 9 lines 29-31) have the inconvenience of presenting variations in chemical composition which require permanent adaptations in the manufacturing process, otherwise non-homogenous performance would be obtained.

This is why the search is for a synthetic material whose chemical composition can be controlled and thereby ensure stable performance of the abrasive grains obtained.

However, by reconstituting particles from synthetic material of the same chemical composition as natural bauxite above, larger microstructures are obtained (namely from 1.5 to 2.5 μm) than with natural bauxite (0.5 μm) but which do not give sufficient performance to the grinding as shown below.

Compositions of abrasive grains with synthetic base with high content of alumina with oxide additive are known to the skilled in the art.

The abrasive grains may, depending on the case, be obtained either by grinding of a “solid rock” product consisting of a solid product resulting from the solidification of a liquid product, for example from an electro-fused abrasive product such as corundum, or by sintering of a powder, or by the Sol-gel process generally followed by sintering.

As is known, these properties of solidity and cutting power are principally correlated with heightened density values, in particular a density of at least 3.5 g/cm³ and with a specific size of crystallite microstructure according to the type of process used, and in particular the sintering temperature, generally, the finest size of crystallites possible provided that the density is sufficient. In fact, fine microstructures are sought so that the grains most often and regularly break into small pieces, provided that the microstructure is not too fine and is not accompanied by insufficient density.

The Sol-gel process followed by sintering produces abrasive grains containing a crystalline microstructure with crystalline particles of reduced size, typically less than 1 micron, and generally less than 0.5 μm and presenting good cutting properties.

However, this process is more expensive and involves the use of finer alumina monohydrate, typically of a size less than 5 μm (“boehmite”).

The Sol-gel process followed by sintering is used for the compositions described, in particular for example in the American patents U.S. Pat. Nos. 5,611,829 and 5,645,619 in which the grains produced consist only of Al₂O₃, Fe₂O₃ and SiO₂ with more than 97% of Al₂O₃, and patent US 2013/0074418 in which the grains consist mainly of MgO and CaO and do not contain SiO₂.

US 2004/004990 describes abrasive grains obtained using a fusion process with the use of corundum (fused alumina) and also having here undergone final additional heat treatment to increase resistance as this type of abrasive obtained by fusion includes abrasives of greater hardness but lesser resistance or solidity. The presence of oxides CaO and Fe₂O₃ is never envisaged.

U.S. Pat. No. 7,169,198 describes abrasive grains obtained by simple sintering but with compositions consisting of more than 98% of alumina of very fine quality, in particular with a D50 diameter of 0.5 μm.

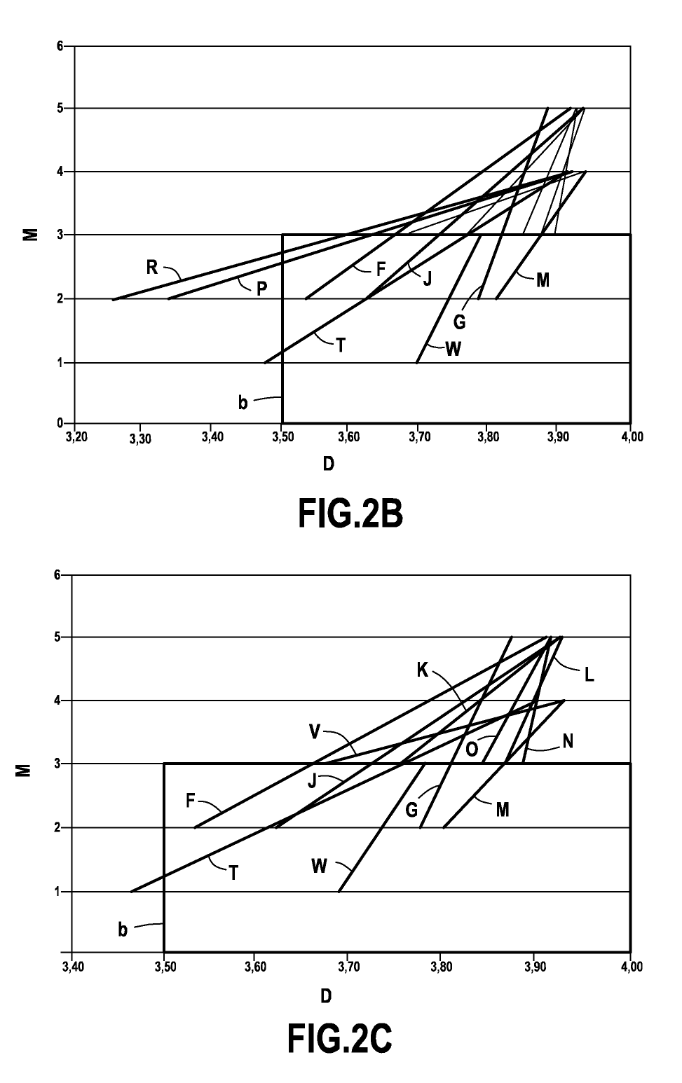

Abrasive particles without magnesium oxide obtained by sintering of various oxide powders are described in U.S. Pat. No. 8,894,730, US 30 8 882 871 and U.S. Pat. No. 8,900,337. In these patents, it was sought to improve the solidity/resistance of the abrasive grains by precipitating a special crystalline phase of FeTiAlO₅ in the grain boundaries to obstruct the propagation of cracks in the crystalline microstructure of the grains. But, it will be seen in FIG. 2 of U.S. Pat. No. 8,900,337 that the microstructure of the grains presents crystallites of average size of the order of at least 5 microns. The large size of the crystallites as well as the phase of precipitation of FeTiAlO₅ in the grain boundaries means that the grain breaks less often or less easily but in the form of larger pieces.

WO01/90030 and US2004/259718 describe resistant insulating materials in particular in US2004/259718 with a view to the preparation of construction materials, rock wool fibres or ceramic fibres, or even a base composition of aluminate dross for the production of iron and steel. These documents do not describe abrasive particles, which require dimensional, density and microstructure characteristics that are not described or suggested in these documents.

The aim of the present invention was to obtain abrasive grains from a new synthetic composition using a process involving simple sintering without fusion or other final additional heat processing and/or without the creation of a special crystalline phase not present in the grains obtained from natural bauxite and with the use of alumina of standard economic quality (with a typical D50 of between 10 and 100 μm) and of oxides present in the natural bauxite and that present optimal grinding performance properties particularly in terms of solidity and cutting power.

To do this, the present invention provides sintered abrasive particles whose chemical composition in the following oxides includes the following ranges of weight content for a total of 100%:

| % Fe₂O₃ | % TiO₂ | % CaO | % MgO | % SiO₂ | % Al₂O₃ |
|---|---|---|---|---|---|
| 0.5-2.5 | 0-2 | 0.5-2.5 | 0.5-3 | 0.5-3 | 93-96.5 |

According to the invention, the sintered abrasive particles present a density of at least 3.5 g/cm³, in particular between 3.6 and 3.8 g/cm³, and a microstructure in which the average size of the crystalline micro-particles is less than 2 μm and in particular between 0.5 and 1.5 μm.

Still more particularly, abrasive particles sintered according to the invention consist of the following ranges of weight content for a total of 100%:

| % Fe₂O₃ | % TiO₂ | % CaO | % MgO | % SiO₂ | % Al₂O₃ |
|---|---|---|---|---|---|
| 0.5-2.5 | 0-2 | 0.5-1.5 | 0.5-2.5 | 0.5-2.5 | 93.5 96.5 |

The particles presenting these chemical compositions above obtained by sintering at a temperature and presenting the characteristics of density and microstructure above presented the best properties in terms of solidity, resistance to compression and grinding test (G ratio), in particular better compared with commercial particles.

According to a first method of realisation, abrasive particles sintered according to the invention that may be obtained at relatively low sintering temperatures of 1300 to 1500° C. present a chemical composition consisting of the following ranges of weight content for a total of 100%:

| % Fe₂O₃ | % TiO₂ | % CaO | % MgO | % SiO₂ | % Al₂O₃ |
|---|---|---|---|---|---|
| 0.5-1.5 | 0.5-2 | 0.5-1.5 | 0.5-1.5 | 1.5-2.5 | 93.5-94.5 |

Preferentially, an abrasive particle sintered according to this first method of realisation, in particular adapted to grinding stainless steel, presents a chemical composition consisting of the following weight content for a total of 100%:

| % Fe₂O₃ | % TiO₂ | % CaO | % MgO | % SiO₂ | % Al₂O₃ |
|---|---|---|---|---|---|
| 1 | 1 | 1 | 1 | 2 | 94 |

According to a second method of realisation, abrasive particles sintered according to the invention that may be obtained at relatively high sintering temperatures of between 1500 and 1700° C. present a chemical composition consisting of the following ranges of weight content for a total of 100%:

| % Fe₂O₃ | % TiO₂ | % CaO | % MgO | % SiO₂ | % Al₂O₃ |
|---|---|---|---|---|---|
| 0.5-1.5 | 0-0.1 | 0.5-1.5 | 1.5-2.5 | 0.5-1.5 | 94.5-95.5 |

Preferentially, an abrasive particle sintered according to this second method of realisation, in particular adapted to grinding stainless steel as well as carbon steel, presents a chemical composition consisting of the following ranges of weight content for a total of 100%:

| % Fe₂O₃ | % TiO₂ | % CaO | % MgO | % SiO₂ | % Al₂O₃ |
|---|---|---|---|---|---|
| 1 | 0 | 1 | 2 | 1 | 95 |

More particularly, the abrasive particles sintered according to the invention present a dimension of 20 μm to 10 mm, preferably in the form of an extended rod of 0.2 to 3 mm in diameter in cross-section and 0.5 to 10 mm in length.

The present invention also provides a process of fabrication of abrasive particles according to the invention, characterised by the following successive stages being realised:
(a) Mechanically homogenised mixture, typically by mixing powders consisting of:
(a1) alumina powder whose particles have an average diameter (expressed as D50) preferentially between 10 μm and 100 μm, added to the mixture proportionally by weight of 93-96.5%,
(a2) iron oxide powder Fe₂O₃ added to the mixture proportionally by weight of 0.5% to 2.5% and preferentially for which the D50 of the particles is about 20 μm,
(a3) calcium oxide powder CaO added to the mixture proportionally by weight of 0.5% to 2.5% and preferentially for which the D50 of the particles is less than 5 μm,
(a4) magnesium oxide powder MgO added to the mixture proportionally by weight of 0.5% to 3% and preferentially for which the D50 of the particles is less than 5 μm,
(a5) silicon oxide powder SiO₂ added to the mixture proportionally by weight of 0.5% to 3% and preferentially for which the D50 of the particles is less than 2 μm, and
(a6) titanium oxide powder TiO₂, added to the mixture proportionally by weight of 0% to 2% and preferentially for which the D50 of particles is less than 5 μm.
(b) Grinding of the mixture preferentially to obtain particles of D50 between 0.5 and 1.5 μm,
(c) Agglomeration under pressure of the powder obtained in this way, to obtain a body of raw paste,
(d) Drying of the paste and cutting or breaking it to obtain particles of the desired sizes,
(e) Sintering of the said particles by baking at a temperature of 1300° C. to 1700° C., and
(f) Filtering of particles to obtain particles of the desired size, preferably between 0.2 and 3 mm in diameter in cross-section and between 0.5 and 10 mm in length.

More particularly, the agglomeration under pressure in stage (c) is compacting by raw extrusion, resulting in the creation of fibres that are then broken such that a body of raw paste can be obtained in the form of a given section and given length.

Still more particularly, in stage (c) the following stages are carried out:
(c1) Mixing of the powders of the mixture in the presence of solvent containing rheology additives to form a paste, preferentially of water containing one or more rheologic agents for mineral filler, and
(c2) Extrusion in the form of a continuous filament of a paste containing preferentially 70 to 90% in weight of powders of mineral mixture.

The rheology agents used as mineral fillers in an aqueous medium may be dispersing agents, lubricants and/or binding agents. Of these agents, particular mention is made of methylcellulose, polyvinyl alcohol, lignin sulfonate, polyacrylate, glycerine, glycerol, ammonium stearate, stearic acid, polyethylene glycol, ethylene glycol, starch, clay, and polycarbonate.

Still more particularly, in stage (d), the drying of the filament and its cutting to length in the form of rods are carried out at the same time.

Still more particularly, in stage (e), the complete cycle consisting of raising the temperature, levelling out at the sintering temperature, then cooling takes between 30 and 120 minutes, typically 60 minutes from cold state to cold state.

Still more particularly, in stage (e), a rotary oven is used in continuous operation.

In an initial mode of realisation, in stage (e), the sintering temperature is 1300° C. to 1500° C., in particular 1400° C., and particles of the following chemical composition are prepared using the following ranges of weight content of the following powders of different oxides for a total of 100%:

| % Fe₂O₃ | % TiO₂ | % CaO | % MgO | % SiO₂ | % Al₂O₃ |
|---|---|---|---|---|---|
| 0.5-1.5 | 0.5-2 | 0.5-1.5 | 0.5-1.5 | 1.5-2.5 | 93.5-94.5 |

In a second method of realisation, in stage (e), the sintering temperature is between 1500° C. and 1700° C., in particular 1600° C., and particles of the following chemical composition are prepared using the following ranges of weight content of powders of the following various oxides for a total of 100%:

| % Fe₂O₃ | % TiO₂ | % CaO | % MgO | % SiO₂ | % Al₂O₃ |
|---|---|---|---|---|---|
| 0.5-1.5 | 0-0.1 | 0.5-1.5 | 1.5-2.5 | 0.5-1.5 | 94.5-95.5 |

The present invention also provides an abrasive product, in particular an “applied” product, such as an abrasive paper or an abrasive canvas, or preferentially a compacted product such as a grinder to be used in particular for scarfing steel slabs, characterised by having abrasive particles according to the invention.

In the compositions above, for CaO and MgO, a start is made with a carbonate powder CaCO₃ and MgCO₃ by adapting the proportions to obtain the desired proportions of CaO and MgO.

Other characteristics and advantages of the present invention will be better understood on a reading of the detailed description of examples of realisation that are going to follow, produced as an illustration and without limitation as a reference to the attached drawings on which the following are shown:

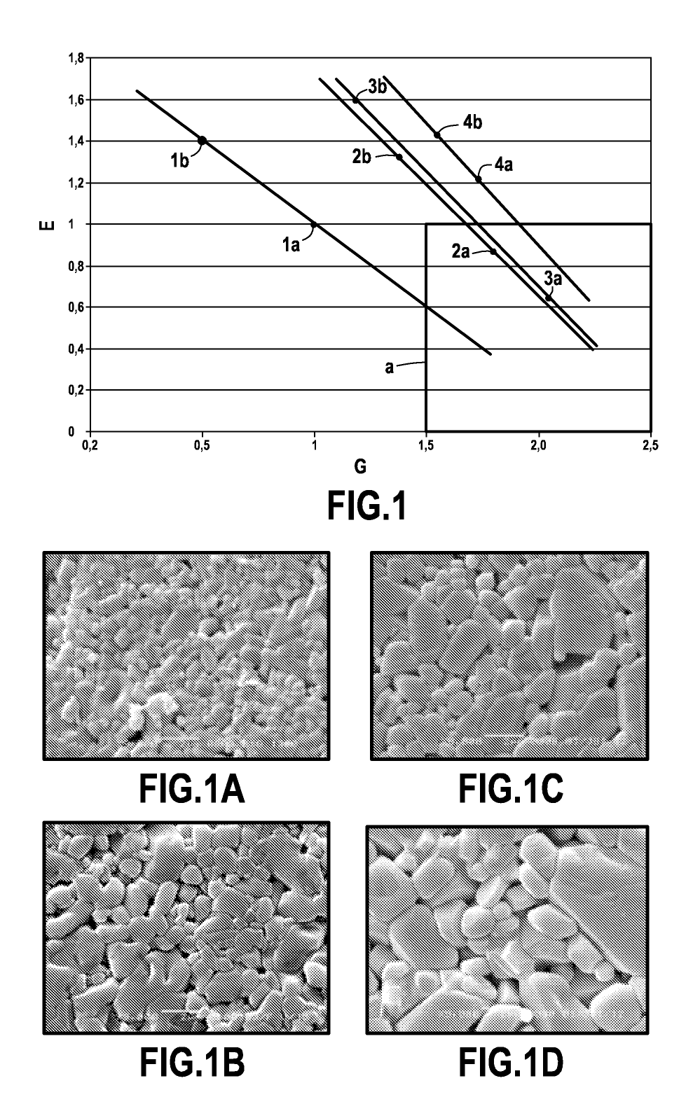

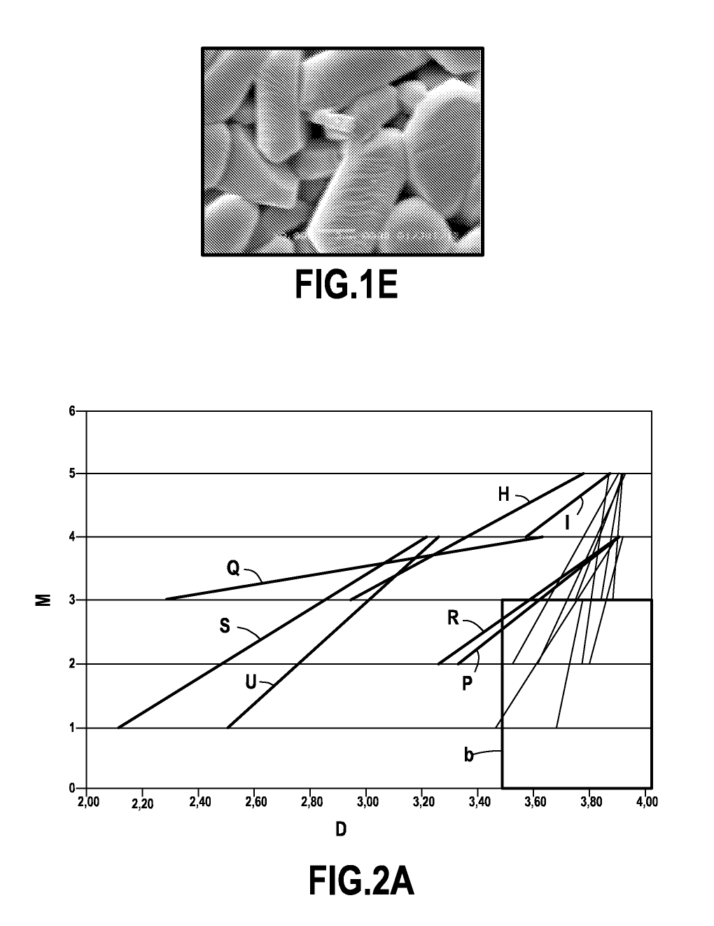

FIG. 1 is a graph showing the development of the G ratio as a function of compression energy E (mJ) necessary to break up the grain for the different compositions nos. 1a to 4b, with G as the abscissa and E as the ordinate being relative values Gi=gᵢ/g₁ₐ and Ei=eᵢ/e₁ₐ for composition no. i (i=1a to 4b);

FIGS. 1A to 1E illustrate the sizes of crystals on the arbitrary scale of 1 to 5 explained below;

FIGS. 2A, 2B and 2C are graphs illustrating the development of the microstructure (“M”) as a function of the density (“D” in g/m³); and

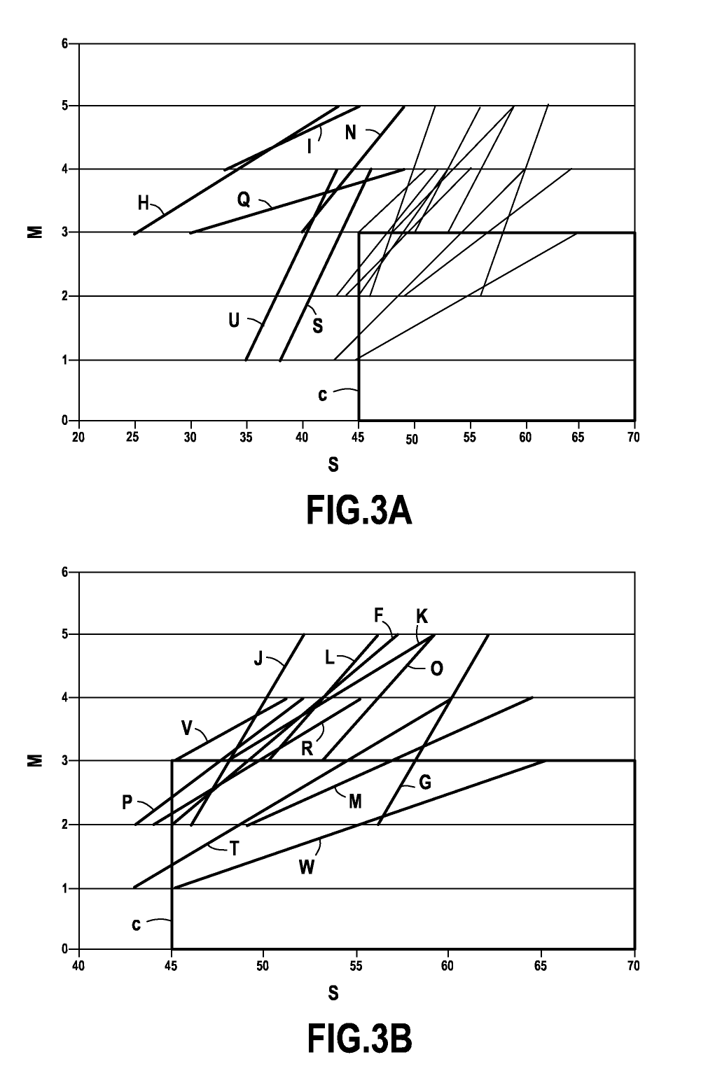

the two FIGS. 3A and 3B are graphs illustrating the development of the microstructure as a function of the solidity (“S”).

### A. PROCESS OF FABRICATION OF THE PARTICLES OR ABRASIVE GRAINS

The process of fabrication of the abrasive grains of synthetic sintered bauxite tested below includes the following stages:
A.1) Realisation of a mixture containing alumina powder obtained from natural bauxite by the Bayer process and powders of various metallic oxides whose proportions for a total of 100% are given in Table 1 below and whose commercial references, suppliers and D50 values are explained in Table 11 below. For CaO and MgO, carbonate powders CaCO₃ and MgCO₃ may be used by adapting the proportions to obtain the desired proportions of CaO and MgO.

TABLE I

| % Fe₂O₃ | % TiO₂ | % CaO | % MgO | % SiO₂ | % Al₂O₃ |
|---|---|---|---|---|---|
| 0-7.5 | 0-7.5 | 0-2.5 | 0-2.5 | 0-3 | 80-98.5 |

TABLE II

| Fe₂O₃ | TiO₂ | CaO | MgO | SiO₂ | Al₂O₃ |
|---|---|---|---|---|---|
| Hematite | Rutile R320 | CaCO₃ | MgCO₃ | Sipernat | AR12 |
| | | Mikhart 2 | CarboMag | 320DS | |
| Arcelor | Sachtleben | S.A. | Brenntag | Sobotram | Alteo |
| Mital | Chemie | Provençal | (FR) | (FR) | Gardanne |
| (FR) | GmbH (DE) | (FR) | | | (FR) |
| 20 μm | 3 μm | 3 μm | 3 μm | 0.5 μm | 45-70 μm |

A.2) The mixture of powders is homogenised mechanically (grinding by steel ball bearings) so as to obtain a mixture with particles of average D50 size of between 0.5 and 1.5 μm and preferentially less than 1 μm and a D90 size less than 15 μm and preferentially between 6 and 10 μm.

D50=diameter for which 50% of the particles have a diameter less than this value,

D90=diameter for which 90% of the particles have a diameter less than this value.

As an illustration, the D50 and D90 values are given in Table III for the two examples preferred according to the present invention:
Composition G: 1% CaO+1% TiO₂+1% MgO+1% Fe₂O₃+2% SiO₂+94% Al₂O₃
Composition W: 1% CaO+0% TiO₂+2% MgO+1% Fe₂O₃+1% SiO₂+95% Al₂O₃

TABLE III

| Composition (no.) | D50 average (μm) | D90 average (μm) |
|---|---|---|
| G | 0.9 | 8.4 |
| W | 0.8 | 8.7 |

A.3) Realisation of a paste that is then extruded to obtain raw bodies

The powder obtained in the previous stage (mixture of alumina and other oxides naturally present in bauxite) is introduced into a mixer together with a solvent containing rheologic additives of 25 to 40% by weight compared with the weight of the powder mixture in order to form a paste.

The solvent preferentially used is water. Several types of rheologic additives are used, as follows:
A dispersing agent for mineral filler, lignin sulfonate or other composites such as polyethylene glycol, ethylene glycol, fish oil, polycarbonate, polyacrylate;
A binding agent for mineral filler, methylcellulose or other composites such as polyvinyl alcohol, clay, starch, emulsified acrylate;
A lubricating agent, glycerine or other composites such as glycerol, stearic acide, ammonium stearate.
A.4) The paste obtained is then compacted and spun to obtain raw bodies. The pressure during the spinning is measured and controlled in order to obtain raw bodies of good quality. The spinning pressures in the extruder are between 50 and 150 bars and preferentially between 80 and 120 bars in order to obtain a paste containing 70 to 90% in weight of powders of mineral mixture.

The raw bodies are long filaments in circular section of diameters varying according to the grade desired of between 0.5 and 4 mm.
A.5) Drying and cutting to length of the raw paste bodies so as to:
   obtain raw grains of the desired length, and
   eliminate, before sintering, any residual water that may cause defects in the grains and affect the abrasive properties after sintering.
A.6) Sintering of raw grains

The raw grains are then sintered in a rotary oven in continuous operation. The sintering temperature is between 1300° C. and 1700° C. and preferentially between 1400° C. and 1600° C. The complete cycle (raising the temperature—levelling off the sintering temperature—cooling) takes between 30 and 120 minutes, typically 60 minutes from cold state to cold state.
A.7) Sifting of the sintered grains to obtain grains of the dimensions desired

The sample is calibrated at the desired dimensions by selection of the grains whose smallest dimension (the diameter) is in a given range by sifting using two sieves with the two limits on size of grain corresponding to the dimensions of the openings of the meshes of both sieves.

In practice, grains of 0.2 to 3 mm in diameter are selected according to the applications envisaged.

The abrasive grain obtained is characterised by its density, its solidity, its microstructure and its resistance to compression according to the protocols explained below.

### B. PROTOCOLS FOR MEASURING GRAIN CHARACTERISTICS

B.1) Solidity (example for a Grade 12 grain)

The sample is calibrated by selection of grains of between 1.7 and 2 mm by sifting using two sieves (1.7 and 2 mm mesh opening).

The sample is ground by mechanical loading, typically by rotation in a jar filled with steel ball bearings. The sifting column used includes the following sieves, defined by the size of the opening of their meshes: 1 mm; 0.5 mm; 0.25 mm and 0.125 mm. The fractions of powder relating to each of the following dimensional classes are recovered according to the diameter of the grain:

c1: D>1 mm

c2: 1 mm>D>0.5 mm

c3: 0.5 mm>D>0.25 mm

c4: 0.25 mm>D>0,125 mm c5: 0.125 mm>D

If Ti is taken to express the relative weight of the fraction of powder recovered in particle dimensional class i (namely, the ratio (fraction mass i)/(initial mass of the sample before the test)), the solidity is expressed by the following relation:

Solidity=4×T1+2×T2+1×T3+0.5×T4+0.25×T5

To ensure that the initial powder corresponds to an index of 100, the preceding value is divided by the sum of the weighting coefficients. It may be noted that with this formula the greater the importance of the mesh of the last sifting (D<0.125 mm in the present case), the lower is the value obtained; the corresponding abrasive was extremely fragmented, generated a large number of finely divided matter and as a result obtains a much lower solidity value.
B.2) Crystalline microstructure of the grains

To be able to observe the microstructure of the grains with a scanning electronic microscope (SEM), a ceramographic preparation of the samples is necessary. The samples are prepared in the following four stages:
1. Fixing the samples on a metal pad in a single layer using an adhesive;
2. Polishing of the grains with a flat rotary polisher and silicon carbide (SiC) disks, of grain size decreasing from 200 μm to 15 μm. The surface is cleaned between each polishing stage with water and then with ethanol. Lastly, the final polishing is made on felt surfaces covered with a diamond polishing paste with grain size going from 15 μm to 1 μm in order to obtain a surface with a “mirror” finish;
3. Removal of the fixing adhesive;
4. To be able to study the crystalline structure of the grains, their surface is revealed by heat treatment at a temperature lower than the sintering temperature.

The microstructure of the grains prepared in this way is observed using a scanning electron microscope (SEM) in secondary electron mode (Jeol JSM 5510) possessing maximum magnification of ×30000. The images are then analysed using image processing software that supplies the equivalent diameter of the circle which represents the diameter of a circle that would have the same surface as the grain analysed.

FIGS. 1A to 1E illustrate the sizes of crystals on an arbitrary scale of 1 to 5 as indicated below:

FIG. 1A, scale 1: about 0.5 μm (from 0.3 to 0.6 μm)

FIG. 1B, scale 2: about 1.0 μm (between 0.6 and 1.3 μm)

FIG. 1C, scale 3: about 1.5 μm (from 1.3 to 1.8 μm)

FIG. 1D, scale 4: about 2.0 μm (between 1.8 and 2.5 μm)

FIG. 1E, scale 5: >2.5 μm.
B.3) Density

The pycnometric density is similar to the density structure of the grains; this enables an assessment to be made of the density of the skeleton of the grains. It only takes account of the “open” porosity, an accessible porosity materialised by cracks and surface porosity. This density does not allow measurement of the “closed” porosity which is materialised by non-accessible, inter- or intra-granular porosity.

The method of measuring the pycnometric density consists in introducing 25 g of grains into a previously weighed phial filled with water, and to measure the difference in mass: Mass (water+grains)−Mass (water).

This mass reduced in volume gives the pycnometric density of the grain. The pycnometric density is expressed in g/cm³.
B.4) Resistance to compression

With an Instron mechanical press equipped with a compression unit, a compression test is carried out on a grain positioned vertically between the lower support and the mobile cross member. The cross member gradually exerts a load on the grain with a descent speed of 0.03 mm/min. The load and the movement of the cross member are measured during the test and a calculation is made, from the dimensions of the grain, of the force applied to the sample as well as its deformation. The compression test is carried out on 30 grains.

The load-movement curve always begins with a gradual increase in the load (elastic deformation of the material) until the grain starts to break up. This is then shown by a fall in the load. If the sample is completely broken, the load then decreases to zero. The maximum load borne by the sample then corresponds to the maximum force of the compression resistance of the sample.

The sample may only be partially broken (it crumbles) and retain sufficient integrity to continue with the test. In this event, the first fall in the load is then followed by an increase in it. This crumbling mechanism may be repeated several times until the grain has completely disintegrated which is shown by a zero load. The area under the load-movement curve allows the energy required completely to break the grain to be calculated.

This crumbling phenomenon is representative of what the grain undergoes in a grinder. The compression resistance energy is a good indicator of the performance of the grain in an abrasive item.
B.5) G ratio

Organic resin grinders were fabricated for the samples of the compositions tested. Before the grinding test, the grinder is weigh together with a stainless steel slab. A grinding test is carried out over a fixed pre-defined period. After the test, the grinder and the steel slab are weighed again. The G ratio corresponds to the ratio between the mass of steel removed and the wear on the grinder. The higher the quantity of steel removed and the more restricted the wear on the grinder, the greater the G ratio is.

### C. EXAMPLES OF CHEMICAL COMPOSITIONS TESTED

C.1 Comparison of natural bauxite and synthetic bauxite

The chemical composition of the natural bauxite used to fabricate sintered grains of bauxite is typically: 1% CaO, 4% TiO₂, 0.2% MgO, 3.5% Fe₂O₃, 3% SiO₂ and 88.3% Al₂O₃. This chemical composition was reproduced synthetically. Grains with both of these raw materials (natural bauxite and synthetic bauxite) were realised and sintered at 3 sintering temperatures: 1300, 1400 and 1500° C.

The characteristics of the grains are presented in Table A below in which the microstructures are qualified on the arbitrary scale of 1 to 5 explained above.

TABLE A

| Sintering | Characteristics | Raw material | |
|---|---|---|---|
| temperature | of grains | Natural bauxite | Synthetic bauxite |
| 1300° C. | Density (g/cm³) | 3.71 | 3.74 |
| | Microstructure | 1 | 3 |
| | Solidity | 62 | 49 |
| 1400° C. | Density (g/cm³) | 3.64 | 3.85 |
| | Microstructure | 3 | 4 |
| | Solidity | 84 | 59 |
| 1500° C. | Density (g/cm³) | Not realised | 3.86 |
| | Microstructure | | 5 |
| | Solidity | | 60 |

C.2 Compression link—G ratio (or “Q ratio”)

The graph in FIG. 1 below represents for different chemical compositions of sintered abrasive grains the development of the G ratio according to the energy required fully to disintegrate this type of abrasive grain using a compression test (as a reminder, the energy indicated on the graph corresponds to an average of over 30 grains). The energy values are expressed in relation to the sample of composition no. 1a which is used as a reference.

Organic resin grinders were fabricated for the 8 samples, details of which are given in Table B.1 below.

TABLE B.1

| Composition | % | % | % | % | % | % | Sintering |
|---|---|---|---|---|---|---|---|
| no. | CaO | TiO₂ | MgO | Fe₂O₃ | SiO₂ | Al₂O₃ | temper |
| 1a | 1 | 4 | 0.2 | 3.5 | 3 | 88.3 | T1 |
| 1b | 1 | 4 | 0.2 | 3.5 | 3 | 88.3 | T2 |
| 2a | 0.5 | 0.5 | 0.2 | 0 | 0.4 | 98.4 | T′1 |
| 2b | 0.5 | 0.5 | 0.2 | 0 | 2.0 | 98.4 | T′2 |
| 3a | 1 | 1 | 1 | 1 | 2 | 94 | T1′ |
| 3b | 1 | 1 | 1 | 1 | 2 | 94 | T2′ |
| 4a | 1 | 0 | 2 | 1 | 1 | 95 | T1″ |
| 4b | 1 | 0 | 2 | 1 | 1 | 95 | T2″ |

For the different chemical compositions tested, minimising the energy measured under compression significantly increases the G ratio.

Table B.2 below indicates for each type of abrasive grain the raw material used to fabricate the abrasive grain, together with the characteristics of the grain: density, microstructure (“micro” for short) and solidity.

TABLE B.2

| Composition | | | Density | |
|---|---|---|---|---|
| no. | Raw material | Micro | (g/cm³) | Solidity |
| 1a | Natural bauxite | 1 | 3.65 | 71 |
| 1b | Synthetic bauxite of same | 4 | 3.72 | 55 |
| | composition as | | | |
| | natural bauxite | | | |
| 2a | Synthetic composition | 3 | 3.70 | 50 |
| 2b | (Al₂O₃ = 98%) | 3 | 3.62 | 57 |
| 3a | Synthetic composition | 1 | 3.71 | 53 |
| 3b | (Al₂O₃ = 94%) | 4 | 3.78 | 70 |
| 4a | Synthetic composition | 3 | 3.68 | 69 |
| 4b | (Al₂O₃ = 95%) | 2 | 3.71 | 53 |

The sample of composition no. 1a corresponds to abrasive grains manufactured from natural bauxite. The typical chemical composition of this bauxite is 1% CaO, 4% TiO₂, 0.2% MgO, 3.5% Fe₂O₃, 3% SiO₂ and 88.3% Al₂O₃. This chemical composition has been reproduced synthetically and corresponds to the sample of composition no. 1b.

The synthetic reproduction of the chemical composition of the natural bauxite does not allow the same G ratio or the same energy to be obtained. This does not seem surprising since both of these types of grain do not possess the same characteristics: density, microstructure and solidity.

To gain a better understanding of this difference in the characteristics of the grains according to the raw material used, grains with both of these raw materials (natural bauxite and synthetic bauxite with the same chemical composition) were produced and sintered at 3 sintering temperatures: 1300, 1400 and 1500° C. The characteristics of the grains are presented in Table A above. With natural bauxite, the density-microstructure-solidity compromise of the sample of composition no. 1a is attained for a sintering temperature of about 1300° C. At 1400° C., the solidity has substantially increased but the microstructure starts to become too big. A comparison of the characteristics of the grains produced from both raw materials shows that synthetic bauxite reproducing the chemical composition of natural bauxite does not allow, in the range of temperature studied, the same density-microstructure-solidity compromise to be attained. In fact, the synthetic composition causes microstructures that are much bigger with lesser solidity.

To try to obtain from a synthetic raw material the characteristics of abrasive grains approaching those fabricated with natural bauxite and in particular reducing the compression energy, grains with three (03) different chemical compositions (alumina with different additive oxides naturally present in the bauxite) but with heightened alumina content (between 94 and 98%) were fabricated. These grains were sintered at two different temperatures between 1400° C. and 1600° C. each time (T1/T2, T1′/T2′ etc.) which correspond to the samples 2a-2b, 3a-3b et 4a-4b on the graph in FIG. 1 and Tables B.1 and B. 2.

For the first synthetic composition (samples of composition nos. 2a and 2b), the microstructure is finer than the sample of composition no. 1b but the solidity is of the same order of size. The sample with this chemical composition having the weakest energy (sample of composition no. 2a) gives a CG ratio that is 3 (three) times higher than the synthetic sample reproducing the composition of natural bauxite (sample of composition no. 1b) and 1.7 times higher than the sample produced with natural bauxite (sample of composition no. 1a). As is already the case for grains fabricated with natural bauxite, reducing the microstructure has a direct and positive influence on the performance of the grain in application.

For the sample of the second chemical composition with the minimum of compression energy (sample of composition no. 3a), the microstructure is much finer than the sample of composition no. 1b (and equivalent to the sample of composition no. 1a) but with the same level of solidity as the sample of composition no. 1b. This sample obtains a G ratio 3.5 times higher than the sample of composition no. 1b and 2 times higher than the sample of composition no. 1a. These results confirm that the influence of the microstructure on the G ratio and the compression energy is therefore of the first order.

For the sample of composition no. 4a with the minimum compression energy, the microstructure is less fine than the sample of composition no. 3a but finer than the sample of composition no. 1b. Conversely, the level of solidity is greater than both of these samples and comparable to the sample of composition no. 1a. This sample of composition no. 4a produces a G ratio 3 times higher than the sample of composition no. 1b and 1.7 times greater than the sample of composition no. 1a. With this sample of composition no. 4a, the same level of performance is obtained as with the sample of composition no. 2a although the compression energy is higher. This reduces the potential gain of this composition no. 4a if the compression energy is reduced even further in particular by reducing the size of the microstructure.

These examples show the direct link between the compression energy and the G ratio. According to the chemical compositions, the correlation between the compression energy and the G ratio has almost the same slope but has a tendency to shift to the right for the synthetic chemical compositions with higher alumina content (FIG. 1). It is clearly shown that minimising the compression energy leads to an increase in the G ratio. The characteristics of the grains have a direct impact on the compression energy.

The objective of this invention is therefore to determine the chemical composition or compositions (and sintering temperatures) for obtaining the lowest compression energy possible. To do this, optimisation of the density-microstructure-solidity ratio is sought. Box a in the graph in FIG. 1 illustrates the zone of interest (minimum energy corresponding to the best G ratios). An analysis of the characteristics of the grains in this box (the samples of composition nos. 2a and 3a) allows selection of the targets to be aimed at for the density, the microstructure and the solidity:

Criterion 1: The finest microstructure possible and not exceeding a size of 3 according to the arbitrary scale and preferentially between 1 and 2.

Criterion 2: Density sufficient, namely greater than 3.5 g/cm³ and preferentially between 3.7 and 3.8 g/cm³.

Criterion 3: Solidity sufficient, namely greater than 45 and preferentially greater than 55.

These criteria are correlated as between themselves. In fact, a grain sintered at high temperature is generally going to have heightened density and solidity but on the other hand a microstructure that is also very large.

Conversely, a grain sintered at low temperature is going to have a finer microstructure but may also not have sufficient mechanical content, that is, a density and/or a solidity that is too low. The objective is therefore to find the chemical composition or compositions coupled with a sintering temperature that can attain the best compromise over all these characteristics.

To do this, work was initially done on the density-microstructure ratio in order to define the preferential ranges of concentration of each oxide. The chemical compositions allowing sufficient density and a fine microstructure to be obtained were then characterised as solidity in order to refine the choice of the chemical composition or compositions of synthetic bauxite allowing the highest performing abrasive grains in application to be obtained.

Therefore, the search was for a grain with the greatest solidity possible equal to at least the solidity of natural bauxite, in order to obtain good cutting power in application.
C.3) Density-microstructure ratio

A large number of compositions were tested in the range of compositions given in Table I above.

As an illustration, the compositions in Table C.1 were tested, among others.

TABLE C.1

| % CaO | % TiO₂ | % MgO | % Fe₂O₃ | % SiO₂ | % Al₂O₃ |
|---|---|---|---|---|---|
| 0 | 7.5 | 0 | 7.5 | 0 | 85 |
| 1.25 | 3.75 | 1.25 | 3.75 | 0 | 90 |
| 2.5 | 7.5 | 0 | 0 | 0 | 90 |
| 2.5 | 7.5 | 2.5 | 7.5 | 0 | 80 |
| 0 | 0 | 0 | 7.5 | 0 | 92.5 |
| 1.25 | 0 | 0 | 7.5 | 0 | 91.25 |
| 2.5 | 7.5 | 0 | 7.5 | 0 | 82.5 |
| 0 | 7.5 | 2.5 | 0 | 0 | 90 |
| 2.5 | 0 | 0 | 0 | 0 | 97.5 |
| 1.25 | 0 | 2.5 | 7.5 | 0 | 88.75 |
| 2.5 | 0 | 2.5 | 7.5 | 0 | 87.5 |
| 1.25 | 7.5 | 0 | 7.5 | 0 | 83.75 |
| 0 | 7.5 | 2.5 | 7.5 | 0 | 82.5 |
| 1.25 | 7.5 | 2.5 | 0 | 0 | 88.75 |
| 1.25 | 0 | 2.5 | 0 | 0 | 96.25 |
| 0 | 0 | 0 | 0 | 0 | 100 |
| 2.5 | 0 | 0 | 7.5 | 0 | 90 |
| 0 | 7.5 | 0 | 0 | 0 | 92.5 |
| 1.25 | 7.5 | 2.5 | 7.5 | 0 | 81.25 |
| 0 | 0 | 2.5 | 7.5 | 0 | 90 |
| 0 | 0 | 2.5 | 0 | 0 | 97.5 |
| 2.5 | 0 | 2.5 | 0 | 0 | 95 |
| 2.5 | 7.5 | 2.5 | 0 | 0 | 87.5 |
| 1.25 | 0 | 0 | 0 | 0 | 98.75 |
| 1.25 | 7.5 | 0 | 0 | 0 | 91.25 |
| 0 | 1 | 0.5 | 0 | 0 | 98.5 |
| 0 | 2 | 1 | 0 | 0 | 97 |
| 0 | 0 | 0.5 | 1 | 0 | 98.5 |
| 0 | 0 | 1 | 2 | 0 | 97 |
| 0 | 1 | 0.5 | 0 | 2 | 96.5 |
| 0 | 2 | 1 | 0 | 2 | 95 |
| 0 | 2 | 2 | 0 | 2 | 94 |
| 1 | 1 | 1 | 1 | 1 | 95 |
| 1 | 1 | 1 | 1 | 2 | 94 |
| 0 | 2 | 2 | 2 | 0 | 94 |
| 2 | 2 | 0 | 2 | 0 | 94 |
| 1 | 1 | 1 | 2 | 1 | 94 |
| 2 | 0 | 2 | 0 | 2 | 94 |
| 0 | 2 | 0 | 2 | 2 | 94 |
| 0 | 2 | 2 | 0 | 2 | 94 |
| 0 | 0 | 0 | 2 | 0 | 98 |
| 1 | 1 | 0 | 1 | 1 | 96 |
| 1 | 2 | 1 | 1 | 1 | 94 |
| 0 | 1 | 1 | 1 | 1 | 96 |
| 2 | 2 | 2 | 2 | 2 | 90 |
| 2 | 0 | 0 | 2 | 2 | 94 |
| 2 | 0 | 0 | 0 | 0 | 98 |
| 1 | 1 | 2 | 1 | 1 | 94 |
| 0 | 2 | 0 | 0 | 0 | 98 |
| 1 | 1 | 1 | 1 | 0 | 96 |
| 0 | 0 | 0 | 0 | 2 | 98 |
| 1 | 1 | 1 | 0 | 1 | 96 |
| 2 | 2 | 2 | 0 | 0 | 94 |
| 1 | 0 | 1 | 1 | 1 | 96 |
| 0 | 0 | 2 | 0 | 0 | 98 |
| 2 | 0 | 2 | 2 | 0 | 94 |
| 0 | 0 | 2 | 2 | 2 | 94 |
| 2 | 1 | 1 | 1 | 1 | 94 |
| 2 | 2 | 0 | 0 | 2 | 94 |
| 0 | 1 | 2 | 0 | 2 | 95 |
| 0 | 0 | 2 | 1 | 2 | 95 |

As explained below, the best results were provided for different chemical compositions of synthetic bauxite for which each oxide (Fe₂O₃, SiO₂, TiO₂, CaO and MgO) varies as indicated in Table C.2 below and with data for density and microstructure corresponding to the sintering carried out at 1400 and 1600° C. in Table C.4 for the compositions preferred.

TABLE C.2

| Oxide | SiO₂ | Fe₂O₃ | TiO₂ | MgO | CaO | Al₂O₃ |
|---|---|---|---|---|---|---|
| (%) | 0.5-2.5 | 0.5-2.5 | 0-2 | 0.5-2.5 | 0.5-1.5 | 93.5-96.5 |

A reference composition (hereinafter referred to as “the Reference composition”) with 100% Al₂O₃, that is, a chemical composition with alumina only (free of SiO₂, TiO₂, Fe₂O₃, MgO and CaO) was tested, which did not produce a grain with the density-microstructure ratio desired. In fact, the density is not sufficient with sintering at 1400° C., and at 1600° C. the microstructure is much too big (Table C.3). It is therefore necessary to add other oxides to alumina in order to be able to meet the objective.

The different oxides were added separately. For example, for compositions A, B, C, D and E in Table 0.3 below: all the oxides are equal to 0% except for 1 oxide at 2% (Al₂O₃ constant at 98%). At 1400° C., none of these chemical compositions allows sufficient density to be obtained apart from composition E with 2% of TiO₂ but it has a microstructure that is too high. At 1600° C., the microstructure is too high for all these compositions. If a comparison is made with the Reference composition at 1400° C., it is found that:
the addition of TiO₂ can significantly increase the density (+0.7 g/cm³) but the microstructure also increases substantially (going from 2 to 4 on the arbitrary scale: +2);
the addition of SiO₂ increases the density (+0.2 g/cm³) and reduces the microstructure (−1);
the addition of MgO and CaO slightly reduces the density (−0.1 g/cm³) and slightly increases the microstructure (+1);
the addition of Fe₂O slightly increases the density (+0.1 g/cm³) and also increases the microstructure (+1).

With composition F, all the oxides are equal to 1% (Al₂O₃ 95%). The combination, of up to 1%, of all the oxides naturally present in bauxite allows the density-microstructure compromise sought to be obtained at 1400° C. It is therefore interesting to combine several oxides and simultaneously to vary their concentration in the mixture to see the impact of each one on the properties of the grains in order to define the optimum ranges of concentration of each oxide in order to meet the objective sought.

TABLE C.3

| | | | | | | | 1400° C. | | 1600° C. | |
|---|---|---|---|---|---|---|---|---|---|---|
| Composition | % | | % | % | | | Density | | Density | |
| no. | CaO | % | MgO | Fe₂0₃ | % | % | (g/ | Micro | (g/ | Micro |
| Ref | 0 | 0 | 0 | 0 | 0 | 100 | 2.78 | 2 | 3.64 | 4 |
| A | 0 | 0 | 0 | 2 | 0 | 98 | 2.82 | 3 | 3.87 | 4 |
| B | 2 | 0 | 0 | 0 | 0 | 98 | 2.69 | 3 | 3.31 | 4 |
| C | 0 | 0 | 2 | 0 | 0 | 98 | 2.70 | 3 | 3.72 | 4 |
| D | 0 | 0 | 0 | 0 | 2 | 98 | 2.98 | 1 | 3.91 | 4 |
| E | 0 | 2 | 0 | 0 | 0 | 98 | 3.47 | 4 | 3.84 | 5 |
| F | 1 | 1 | 1 | 1 | 1 | 95 | 3.53 | 2 | 3.91 | 5 |

Table C.4 below illustrates different chemical compositions of synthetic bauxite for which each oxide (Fe₂O₃, SiO₂, TiO₂, CaO and MgO) varies between 0 and 2% with density and microstructure data corresponding to two sintering operations carried out at 1400 and 1600° C.

The three graphs in FIGS. 2A, 2B and 2C illustrate for each of the 18 chemical compositions the development of the microstructure depending on the density (corresponding to two sessions of sintering carried out at 1400° C. and 1600° C.). Box b represents the target aimed at, namely a density >3.5 g/cm³ and a microstructure not exceeding 3 on the arbitrary scale.

Five (5) chemical compositions: H, I, Q, S and U, have a density-microstructure ratio that does not fall within box b FIG. 2A. These chemical compositions are excluded as they will not be able to attain the density and microstructure sought, irrespective of the sintering temperature. Their common point is the absence of SiO₂. As a result, the leading criterion is the presence of SiO₂ in the composition of synthetic bauxite sought.

The development of the microstructure according to the density of the chemical compositions P and R pass into box b only for a very restricted temperature range as shown in FIG. 2B. These chemical compositions P and R are not favourable as they require very precise control of the sintering temperature in a small temperature zone. These compositions P and R do not contain Fe₂O₃. It would therefore appear that the absence of Fe₂O₃, like the absence of SiO₂, is against obtaining the density-microstructure ratio sought. Additionally, if the remaining compositions F, G, J, K, L, M, N, O, T, V and W, which meet the objective, are examined, they all possess between 1 and 2% of Fe₂O₃.

At this stage, the two criteria for the chemical composition which appear are the presence of SiO₂ and Fe₂O₃. All the chemical compositions with 1 to 2% of each of these two oxides can produce a grain with sufficient density and a fine microstructure. The range of variation of these two oxides (SiO₂ and Fe₂O₃) is therefore fixed between 0.5 and 2.5%.

Regarding the other 3 oxides, it is noted that a variation between 0 and 2% of each of them can obtain a good density-microstructure ratio. However, certain preferential zones may be shown by examining in greater detail the chemical compositions F, G, J, K, L, M, N, O, T, V and W.

FIG. 2C shows the chemical compositions that allow the finest microstructure to be obtained. In FIG. 2C, 6 chemical compositions allow a fine microstructure fine of 1 or 2 to be obtained according to the arbitrary scale: F, G, J, M, T and W. These compositions all possess 1% of CaO and 1% of MgO (apart from composition W: 2% MgO). The association of these two oxides, which are known to have a strong impact upon grain increase, with a controlled quantity of Fe₂O₃ (1%), SiO₂ (1 to 2%) and TiO₂ (0 to 2%), produces grains of sufficient density (>3.5 g/cm³) and a fine microstructure (comparable to that obtained with natural bauxite). The other compositions: K, L, N, O and V, which possess microstructures of 3 possess either CaO or MgO but not both at the same time.

Only compositions T and W possess at 1400° C. a microstructure of size 1. Their chemical compositions possess several common points, as follows: 0% TiO₂, 1% CaO, 1% Fe₂O₃, 1% SiO₂. Composition W which possesses a density higher than composition T possesses 2% of MgO compared with 1% for composition T.

The two chemical compositions G and M allow a heightened density (and a microstructure <3) to be obtained. Both of these chemical compositions G and M possess at 1400° C. a microstructure of 2 with a density of 3.8 g/cm³. Both of these compositions G and M possess 1% of Fe₂O₃, 1% of MgO and 1% of CaO. The only difference is that the G composition possesses 2% of SiO₂ and composition M 2% of TiO₂. For this type of composition (1% of Fe₂O₃, CaO and MgO), the addition of 2% of TiO₂ instead of 2% of SiO₂ does not modify the density or the microstructure.

Only the chemical composition W is in box b between 1400 and 1600° C. It possesses 0% of TiO₂, 1% of CaO, 1% of Fe₂O₃, 1% of SiO₂ and 2% of MgO.

The preferential content of TiO₂, CaO and MgO is therefore as follows:
0 to 1% of TiO₂. This oxide significantly increases the density as for composition E in Table A but also substantially increases the microstructure. To limit this, the addition of TiO₂ will be a maximum of 1.5%. SiO₂ is preferred to increase the density further as this oxide does not really modify the microstructure or even diminish it (see composition D). Additionally, if a chemical composition is sought that can obtain a density-microstructure ratio in the target sought for a wide range of temperature going up to 1600° C. (see composition W), it is preferable not to add more TiO₂.
1% CaO or in practice 0.5 to 1.5% of CaO, and 1 to 2% MgO or in practice 0.5 to 2.5% of MgO. The chemical compositions for obtaining the finest microstructures (with a density >3.5 g/cm³) all possess 1% of CaO. For the effect of this oxide to be optimised, it is necessary to combine it with MgO of between 1 and 2%.

All the examples in Table C.4 possess a content of Al₂O₃ of between 94 and 96. The range of variation in practice may therefore be fixed between 93.5 and 96.5%.

TABLE C.4

| | | | | | | | 1400° C. | | 1600° C. | |
|---|---|---|---|---|---|---|---|---|---|---|
| Composition | % | | % | | | | Density | | Density | |
| no. | CaO | % | MgO | % | % | % | (g | Micro | (g | Micro |
| F | 1 | 1 | 1 | 1 | 1 | 95 | 3.53 | 2 | 3.91 | 5 |
| G | 1 | 1 | 1 | 1 | 2 | 94 | 3.78 | 2 | 3.88 | 5 |
| H | 0 | 2 | 2 | 2 | 0 | 94 | 2.95 | 3 | 3.79 | 5 |
| I | 2 | 2 | 0 | 2 | 0 | 94 | 3.59 | 4 | 3.88 | 5 |
| J | 1 | 1 | 1 | 2 | 1 | 94 | 3.62 | 2 | 3.93 | 5 |
| K | 0 | 2 | 0 | 2 | 2 | 94 | 3.76 | 3 | 3.93 | 5 |
| L | 1 | 1 | 0 | 1 | 1 | 96 | 3.87 | 3 | 3.93 | 5 |
| M | 1 | 2 | 1 | 1 | 1 | 94 | 3.80 | 2 | 3.93 | 4 |
| N | 0 | 1 | 1 | 1 | 1 | 96 | 3.88 | 3 | 3.92 | 5 |
| O | 2 | 0 | 0 | 2 | 2 | 94 | 3.84 | 3 | 3.92 | 5 |
| P | 1 | 1 | 2 | 0 | 1 | 94 | 3.27 | 2 | 3.92 | 4 |
| Q | 1 | 1 | 1 | 1 | 0 | 96 | 2.29 | 3 | 3.63 | 4 |
| R | 1 | 1 | 1 | 0 | 1 | 96 | 3.34 | 2 | 3.92 | 4 |
| S | 2 | 2 | 2 | 0 | 0 | 94 | 2.11 | 1 | 3.23 | 4 |
| T | 1 | 0 | 1 | 1 | 1 | 96 | 3.47 | 1 | 3.90 | 4 |
| U | 2 | 0 | 2 | 2 | 0 | 94 | 2.51 | 1 | 3.27 | 4 |
| V | 0 | 0 | 2 | 2 | 2 | 94 | 3.67 | 3 | 3.94 | 4 |
| W | 1 | 0 | 2 | 1 | 1 | 95 | 3.69 | 1 | 3.68 | 3 |

C.4) Density-microstructure-solidity ratio

Table D below illustrates different chemical compositions of synthetic bauxite for which each oxide (Fe₂O, SiO₂, TiO₂, CaO and MgO) varies between 0 and 2% with the data for density, microstructure and solidity corresponding to two sessions of sintering carried out at 1400 and 1600° C.

The two graphs in FIGS. 3A and 3B illustrate for each of the 18 chemical compositions the development of the microstructure according to the solidity (corresponding to two sessions of sintering carried out at 1400° C. and 1600° C.). Box c represents the target aimed at, namely a microstructure not exceeding 3 on the arbitrary scale and a solidity >45.

TABLE D

| | | | | | | | 1400° C. | | | 1600° C. | | |
|---|---|---|---|---|---|---|---|---|---|---|---|---|
| Composition | % | | % | | | | Density | | | Density | | |
| no. | CaO | % | MgO | % | % | % | ( [symbol] | Micro. | Solidity | ( [symbol] | Micro. | Solidity |
| F | 1 | 1 | 1 | 1 | 1 | 95 | 3.53 | 2 | 45 | 3.91 | 5 | 57 |
| G | 1 | 1 | 1 | 1 | 2 | 94 | 3.78 | 2 | 56 | 3.88 | 5 | 62 |
| H | 0 | 2 | 2 | 2 | 0 | 94 | 2.95 | 3 | 25 | 3.79 | 5 | 43 |
| I | 2 | 2 | 0 | 2 | 0 | 94 | 3.59 | 4 | 33 | 3.88 | 5 | 45 |
| J | 1 | 1 | 1 | 2 | 1 | 94 | 3.62 | 2 | 46 | 3.93 | 5 | 52 |
| K | 0 | 2 | 0 | 2 | 2 | 94 | 3.76 | 3 | 48 | 3.93 | 5 | 59 |
| L | 1 | 1 | 0 | 1 | 1 | 96 | 3.87 | 3 | 50 | 3.93 | 5 | 56 |
| M | 1 | 2 | 1 | 1 | 1 | 94 | 3.80 | 2 | 49 | 3.93 | 34 | 64 |
| N | 0 | 1 | 1 | 1 | 1 | 96 | 3.88 | 3 | 40 | 3.92 | 5 | 49 |
| O | 2 | 0 | 0 | 2 | 2 | 94 | 3.84 | 3 | 53 | 3.92 | 5 | 59 |
| P | 1 | 1 | 2 | 0 | 1 | 94 | 3.27 | 2 | 43 | 3.92 | 4 | 52 |
| Q | 1 | 1 | 1 | 1 | 0 | 96 | 2.29 | 3 | 30 | 3.63 | 4 | 49 |
| R | 1 | 1 | 1 | 0 | 1 | 96 | 3.34 | 2 | 44 | 3.92 | 4 | 55 |
| S | 2 | 2 | 2 | 0 | 0 | 94 | 2.11 | 1 | 38 | 3.23 | 4 | 46 |
| T | 1 | 0 | 1 | 1 | 1 | 96 | 3.47 | 1 | 43 | 3.90 | 4 | 60 |
| U | 2 | 0 | 2 | 2 | 0 | 94 | 2.51 | 1 | 35 | 3.27 | 4 | 43 |
| V | 0 | 0 | 2 | 2 | 2 | 94 | 3.67 | 3 | 45 | 3.94 | 4 | 51 |
| W | 1 | 0 | 2 | 1 | 1 | 95 | 3.69 | 1 | 45 | 3.78 | 3 | 65 |

[symbol]

indicates data missing or illegible when filed

1) Analysis of solidity at 1400° C.

Chemical compositions H, I, Q, S and U not possessing SiO₂ do not produce suitable solidity (<40). As seen previously, these samples mostly have a very low density, which does not allow them to have sufficient mechanical content. This means that obtaining a minimum density is the main criterion to be met for abrasive grains. An analysis of the densities, microstructures and solidity of these samples confirms that SiO₂ needs to be put in so as to obtain a good compromise. This oxide is one of the 15 most important ones for meeting the objective for density, microstructure and solidity.

Chemical compositions G, K, O and V possess most SiO₂ (2%), presenting a solidity >45. Where they also possess CaO, like compositions G and O, the solidity is still higher >50. This oxide, where it is coupled with SiO₂, significantly increases the solidity. Conversely, it is noted that composition N which possesses 1% of SiO₂, TiO₂, MgO, Fe₂O₃ but not CaO possesses the lowest solidity (if compositions without SiO₂ which have solidity <40 are not considered).

Iron oxide has a limited but positive impact on solidity. A comparison of the chemical compositions R and F which respectively possess 0 and 1% of Fe₂O₃ leads to an increase in the solidity by a single point. The increase is identical when Fe₂O₃ increases from 1 to 2% (chemical compositions F and J). An analysis of the density-microstructure combination of different examples showed the interest of putting in Fe₂O₃ and this is confirmed when solidity is taken into account. The compositions possess the highest solidity: compositions G, L and O possess 1 to 2% of Fe₂O. MgO has a tendency to reduce solidity. A comparison of compositions L and F which respectively possess 0 and 1% of MgO shows a reduction in solidity of 5 points. Conversely, with another association of oxides: 1% CaO, 0% TiO₂, 1% Fe₂O and 1% SiO₂ (chemical compositions T and W), the increase in the concentration of MgO of 1 to 2% allows an increase of 2 points in solidity. It would therefore appear that for certain chemical compositions (compositions T and W for example) this oxide MgO does not have a negative effect on solidity.

Titanium oxide increases solidity. This relates to the fact that the presence of this oxide promotes obtaining greater density for a given temperature. Chemical compositions T, F and M for which the concentration of TiO₂ respectively goes from 0 to 1 then 2% have solidity that increases by 2 points (0 to 1% TiO₂) and 4 points (1 to 2% TiO₂).
2) Analysis of solidity at 1600° C.

At this temperature, with the exception of chemical compositions without SiO₂, all the other chemical compositions allow sufficient solidity (>45) to be attained and meet the objective. This is probably related to the very high densities obtained for this sintering temperature. The grains are sintered at a high temperature which gives them substantial mechanical content.

Conversely, with the exception of composition W, the compositions also have a microstructure that is too large. The absence of TiO₂ coupled with a significant quantity of MgO in chemical composition W (with 1% of each of the other oxides) seems to be the best composition where the sintering is carried out at a higher temperature.

The best chemical compositions (in box c) are G, M, T and W. They possess 1% CaO, 1% Fe₂O₃, 0 to 2% TiO₂, 1 to 2% MgO, 1 to 2% SiO₂ and 94 to 96% of Al₂O₃.

1. A sintered abrasive particle for which the following chemical composition in oxides includes the following ranges of content by weight for a total of 100%:

| % Fe₂O₃ | % TiO₂ | % CaO | % MgO | % SiO₂ | % Al₂O₃ |
|---|---|---|---|---|---|
| 0.5-2.5% | 0-2% | 0.5-2.5% | 0.5-3% | 0.5-3% | 93-96.5% |

with the density of the said particle being at least 3.5 g/cm³ and the said particle presenting a microstructure in which the average size of the crystalline micro-particles is less than 2 μm.

2. An abrasive particle sintered according to claim 1, characterised by presenting a microstructure in which the average size of the crystalline micro-particles is 0.5 to 1.5 μm.

3. An abrasive particle sintered according to claim 1, characterised by its chemical composition containing the following ranges of weight by content for a total of 100%:

| % Fe₂O₃ | % TiO₂ | % CaO | % MgO | % SiO₂ | % Al₂O₃ |
|---|---|---|---|---|---|
| 0.5-1.5% | 0.5-2% | 0.5-1.5% | 0.5-1.5% | 1.5-2.5% | 93.5-94.5% |

4. An abrasive particle sintered according to claim 3, characterised by its chemical composition having the following ranges of weight by content for a total of 100%:

| % Fe₂O₃ | % TiO₂ | % CaO | % MgO | % SiO₂ | % Al₂O₃ |
|---|---|---|---|---|---|
| 1% | 1% | 1% | 1% | 2% | 94% |

5. An abrasive particle sintered according to claim 1, characterised by its chemical composition having the following ranges of weight by content for a total of 100%:

| % Fe₂O₃ | % TiO₂ | % CaO | % MgO | % SiO₂ | % Al₂O₃ |
|---|---|---|---|---|---|
| 0.5-1.5% | 0-0.1% | 0.5-1.5% | 1.5-2.5% | 0.5-1.5% | 94.5-95.5% |

6. An abrasive particle sintered according to claim 5, characterised by its chemical composition containing the following weight by content for a total of 100%:

| % Fe₂O₃ | % TiO₂ | % CaO | % MgO | % SiO₂ | % Al₂O₃ |
|---|---|---|---|---|---|
| 1% | 0% | 1% | 2% | 1% | 95% |

7. An abrasive particle sintered according to claim 1, characterised by presenting a dimension of 20 μm to 10 mm, preferentially in the elongated form of a rod of 0.2 to 3 mm in diameter and 0.5 to 10 mm in length.

8. A process of fabrication of abrasive particles according to claim 1, characterised by the following successive stages being carried out:
a) A mixture homogenised mechanically, typically by mixing of powders consisting of the following:
a1) An alumina powder, preferentially in which the particles have an average diameter (expressed by the D50 diameter of the particles) between 10 μm and 100 μm, added to the mixture proportionally by weight of 93-96.5%,
a2) An iron oxide powder Fe₂O₃ added to the mixture proportionally by weight of 0.5% to 2.5% and preferentially where the D50 of the particles is about 20 μm,
a3) A calcium oxide powder CaO added to the mixture proportionally by weight of 0.5% to 2.5% and preferentially for which the D50 of the particles is less than 5 μm,
a4) A magnesium oxide powder MgO added to the mixture proportionally by weight of 0.5% to 3% and preferentially for which the D50 diameter of the particles is less than 5 μm,
a5) A silicon oxide powder SiO₂ added to the mixture proportionally by weight of 0.5% to 3% and preferentially for which the D50 diameter of the particles is less than 2 μm, and
a6) A titanium oxide powder TiO₂, added to the mixture proportionally by weight of 0% to 2% and preferentially for which the D50 diameter of the particles is less than 5 μm.
b) Crushing of the mixture preferentially in order to obtain particles of D50 diameter of 0.5 to 1.5 μm;
c) Agglomeration under pressure of the powder obtained in this way with a view to obtaining bodies of raw paste;
d) Drying of the bodies of raw paste and cutting or breaking in order to obtain particles of the sizes desired;
e) Sintering of the said particles by baking at a temperature of 1300° C. to 1700° C., and
f) Filtering of the particles to obtain particles of the desired sizes.

9. A process according to claim 8 in which the agglomeration under pressure in stage (c) is compacting by raw extrusion, resulting in the creation of fibres that are then broken such that bodies of raw paste may be obtained in the form of a given section and given length.

10. A process according to claim 8 in which in stage (c) the following stages are carried out:
c1) Mixing of the powders of the mixture in the presence of solvent containing rheology additives to form a paste, preferentially of water containing one or more rheologic agents for mineral filler, and
c2) Extrusion in the form of a continuous filament of a paste containing preferentially 70 to 90% in weight of powders of mineral mixture.

11. A process according to claim 8 in which in stage (d) the drying of the filament and cutting it to length in the form of rods is carried out at the same time.

12. A process according to claim 8 in which in stage (e), the sintering temperature is between 1300° C. and 1500° C. and particles of the following chemical composition are prepared from the following ranges of weight by content of powders of the following different oxides for a total of 100%:

| % Fe₂O₃ | % TiO₂ | % CaO | % MgO | % SiO₂ | % Al₂O₃ |
|---|---|---|---|---|---|
| 0.5-1.5% | 0.5-2% | 0.5-1.5% | 0.5-1.5% | 1.5-2.5% | 93.5-94.5% |

13. A process according to claim 8 in which in stage (e), the sintering temperature is between 1500° C. and 1700° C. and particles of the following composition are prepared from the following ranges of weight by content of the following different oxides for a total of 100%:

| % Fe₂O₃ | % TiO₂ | % CaO | % MgO | % SiO₂ | % Al₂O₃ |
|---|---|---|---|---|---|
| 0.5-1.5% | 0-0.1% | 0.5-1.5% | 1.5-2.5% | 0.5-1.5% | 94.5-95.5% |

14. An abrasive product having abrasive particles according to claim 1.
